(19) United States
(12) Patent Application Publication
(10) Pub. No.: US 2024/0409149 A1
(43) Pub. Date: Dec. 12, 2024

(54) CHILD CARRIER

(71) Applicant: Wonderland Switzerland AG, Steinhausen (CH)

(72) Inventors: Erxue WANG, Steinhausen (CH); Tao YANG, Steinhausen (CH)

(73) Assignee: Wonderland Switzerland AG, Steinhausen (CH)

(21) Appl. No.: 18/695,011

(22) PCT Filed: Oct. 19, 2022
(86) PCT No.: PCT/EP2022/079106

§ 371 Date: Mar. 25, 2024

(30) Foreign Application Priority Data
Oct. 20, 2021 (CN) 202111223148.8

(51) Int. Cl. B62B 9/20; B62B 9/10

(52) U.S. Cl. CPC B62B 9/203; B62B 9/102

(57) ABSTRACT

The present disclosure relates to a child carrier. The child carrier includes a frame, a handle and a seat support member. The handle is pivotally connected to the frame, the seat support member is configured to support a seat, the handle is capable of rotating relative to the frame to drive the seat support member to move relative to the frame from a first position to a second position.

### CROSS-REFERENCE TO RELATED APPLICATIONS

This application claims priority of Chinese Patent Application No.2021112231488, filed on Oct. 20, 2021, entitled “CHILD CARRIER”, the entire content of which is incorporated herein in its entirety.

### TECHNICAL FIELD

The present disclosure relates to carriers, in particular relates to a child carrier.

### BACKGROUND

Currently, some child carriers in the market, such as strollers, can have a function of changing a forward direction by a handle. That is to say, the forward direction of the stroller can be changed by rotating the handle. Before the forward direction is changed by rotating the handle, a center of gravity of the baby is closer to rear wheels. However, after the handle is rotated to change the forward direction, the center of gravity is closer to front wheels, i.e., the rear wheels before the forward direction is changed, which causes pushing of the stroller to become more strenuous and inconvenient. Furthermore, a height of the center of gravity of the stroller cannot be adjusted as required, which results in a poor user's experience.

### SUMMARY

According to some embodiments, a child carrier is provided including a frame, a seat support member configured to support a seat, and a handle pivotally connected to the frame, and the handle is capable of rotating relative to the frame to drive the seat support member to move relative to the frame from a first position to a second position.

The handle of the aforementioned child carrier can be rotated relative to the frame, so that the seat support member can move relative to the frame from the first position to the second position. Since the seat support member is configured to support the seat, the child sitting on the seat can move along with the seat support member, that is, the center of gravity of the entire child carrier is changed. As such, the user can rotate the handle to adjust the center of gravity of the child carrier, so that the center of gravity of the child carrier moves backward after the moving direction of the child carrier is changed by rotating the handle.

In one of the embodiments, the frame includes a support rod, the seat support member is slidably connected to the support rod, and the handle is capable of rotating to drive the seat support member to move along the support rod.

In one of the embodiments, the support rod is arranged along a first direction, the handle is capable of rotating relative to the frame to change a moving direction of the frame from the first direction to a second direction, and to drive the seat support member to move relative to the frame from the first direction to the second direction, and the second position is located in the first direction of the first position.

In one of the embodiments, the child carrier further includes a first linkage assembly, the handle drives the seat support member to move along the support rod through the first linkage assembly.

In one of the embodiments, the first linkage assembly includes a rotating member and a driving member, one end of the rotating member is connected to the handle, another end of the rotating part is pivotally connected to one end of the driving member, and another end of the driving member is pivotally connected to the seat support member.

In one of the embodiments, the rotating member and the driving member are located above the seat support member.

In one of the embodiments, the child carrier further includes a rotating shaft, the rotating shaft is fixed to the handle and extends through the frame to enable the handle to be pivotally connected to the frame, and the end of the rotating member is fixed to the rotating shaft.

In one of the embodiments, the handle includes a handle holder, and the rotating shaft is connected to the handle holder.

In one of the embodiments, the seat support member is slidably sleeved on the support rod.

In one of the embodiments, the child carrier further includes a plurality of pulleys located in the seat support member and abutting against the support rod.

In one of the embodiments, the child carrier further includes a reinforcing sheet covering a side surface of the rotating member.

In one of the embodiments, the child carrier further includes a second linkage assembly, the frame includes a support rod, the seat support member is connected to the support rod through the second linkage assembly, and the handle is capable of rotating to drive the seat support member to move relative to the support rod.

In one of the embodiments, the support rod is arranged along a first direction, the handle is capable of rotating relative to the frame to change a moving direction of the frame from the first direction to a second direction, and to drive the seat support member to move relative to the frame from the first direction to the second direction, the second position is located in the first direction of the first position.

In one of the embodiments, the support rod is arranged along a first direction, and the second position is located above or below the first position.

In one of the embodiments, the second linkage assembly includes a first linkage rod and a second linkage rod, one end of the first linkage rod is fixed to the handle, another end of the first linkage rod is pivotally connected to one end of the seat support member, another end of the seat support member is pivotally connected to one end of the second linkage rod, and another end of the second linkage rod is pivotally connected to the support rod; and the first linkage rod, the seat support member, the second linkage rod, and the support rod are connected in sequence to form a deformable quadrilateral structure.

In one of the embodiments, the first linkage rod, the seat support member, and the second linkage rod are located above the support rod.

In one of the embodiments, the child carrier further includes a rotating shaft, the rotating shaft is fixed to the handle and extends through the frame to enable the handle to be pivotally connected to the frame, and the end of the rotating member is fixed to the first linkage rod.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is a side view of a child carrier according to an embodiment of the present disclosure.

FIG. 2 is an enlarged view of a circled portion A in FIG. 1.

FIG. 3 is a side view of the child carrier in FIG. 1 in another status.

FIG. 4 is an enlarged view of a circled portion B in FIG. 3.

FIG. 5 is a perspective view of the child carrier of FIG. 1.

FIG. 6 is an enlarged view of a circled portion C in FIG. 5.

FIG. 7 is similar to FIG. 5, but viewed from another aspect.

FIG. 8 is an enlarged view of a circled portion D in FIG. 7.

FIG. 9 is a perspective view of a handle in FIG. 5.

FIG. 10 is an enlarged view of a circled portion E in FIG. 9.

FIG. 11 is similar to a FIG. 6, but viewed from another aspect.

FIG. 12 is similar to a FIG. 11, but viewed from another aspect.

FIG. 13 is similar to a FIG. 2, but viewed from another aspect.

FIG. 14 is similar to a FIG. 4, but viewed from another aspect.

FIG. 15 is an enlarged view of FIG. 13.

FIG. 16 is another enlarged view of FIG. 13.

FIG. 17 is a side view of the child carrier according to another embodiment of the present disclosure.

FIG. 18 is a side view of the child carrier in FIG. 17 in another status.

FIG. 19 is a side view of a child carrier according to another embodiment of the present disclosure.

FIG. 20 is a perspective view of the child carrier of FIG. 17.

FIG. 21 is an enlarged view of a circled portion F in FIG. 20.

FIG. 22 is another perspective view of the child carrier of FIG. 17.

FIG. 23 is an enlarged view of a circled portion G in FIG. 22.

FIG. 24 is a perspective view of the child carrier of FIG. 18.

FIG. 25 is an enlarged view of a circled portion H in FIG. 24.

FIG. 26 is a perspective view of a rotating shaft in FIG. 25.

### DETAILED DESCRIPTION OF THE EMBODIMENTS

Embodiments of the invention are described more fully hereinafter with reference to the accompanying drawings. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art. Elements that are identified using the same or similar reference characters refer to the same or similar elements.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

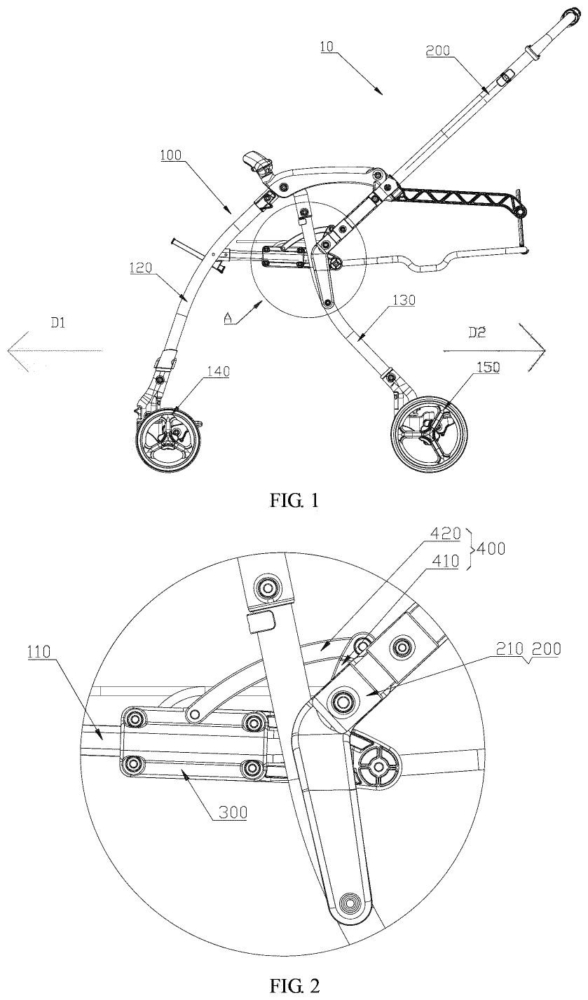

As shown in FIGS. 1 and 2, according to an embodiment of the present disclosure, a child carrier 10, such as a stroller, is provided. The child carrier 10 includes a frame 100, a handle 200, and a seat support member 300. When the handle 200 is rotated, a position of a center of gravity of the child carrier 10 can be adjusted as required, which is convenient for the user to push the child carrier 10 and provides a better user experience.

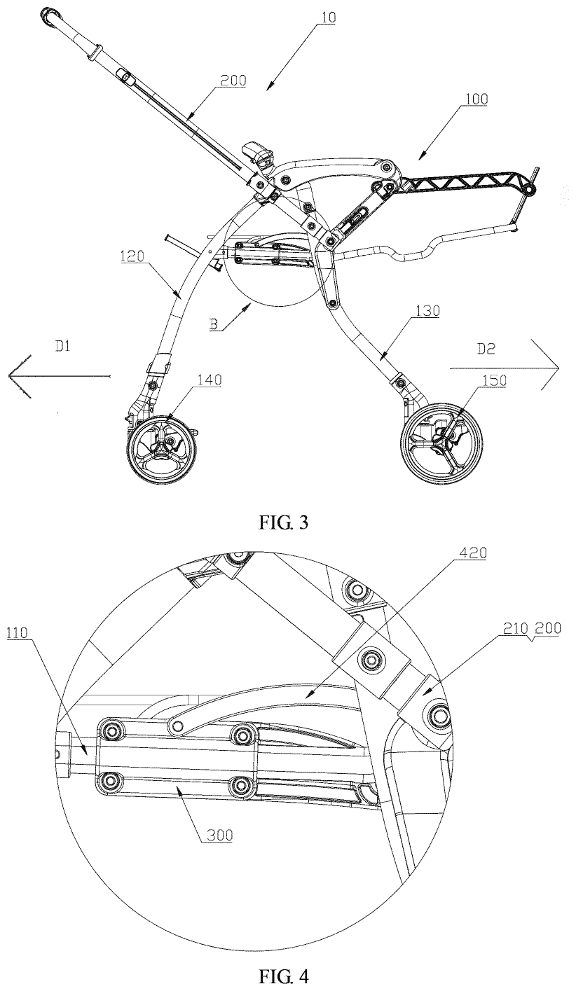

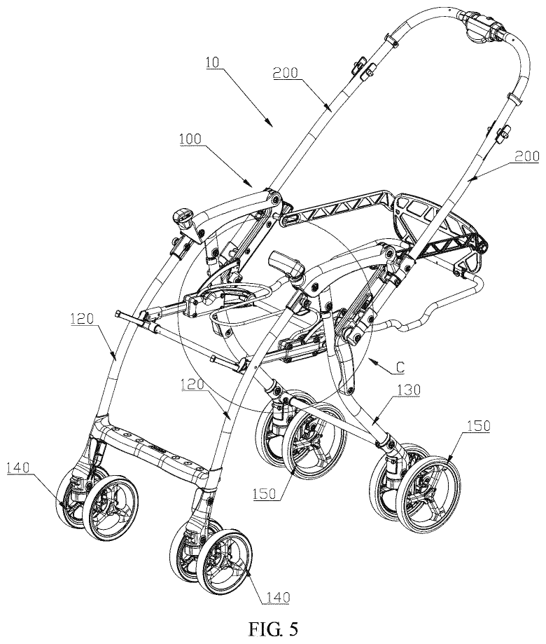

Specifically, as shown in FIGS. 1 to 4, the handle 200 is pivotally connected to the frame 100, and the seat support member 300 is configured to support a seat (not shown in the drawings). The handle 200 is capable of rotating relative to the frame 100 to change a moving direction of the frame 100 from the first direction D1 to a second direction D2, and at the same time drives the seat support member 300 to move relative to the frame 100 from a first position (see FIG. 2) to a second position (see FIG. 4). The second position is located in the first direction D1 of the first position. The first direction D1 may be, for example, a horizontal leftward direction as shown in FIG. 1, and the second direction D2 may be, for example, a horizontal rightward direction as shown in FIG. 1. Taking the second direction D2 (i.e., the moving direction after the handle 200 is rotated) as a reference, the second position is located behind the first position. That is, when the handle 200 is rotated to change the moving direction of the frame 100 from the first direction D1 to the second direction D2, the seat support member 300 is driven to move backward. Since the seat support member 300 is configured to support the seat, the child sitting on the seat will move along with the movement of the seat support member 300, that is, the center of gravity of the entire child carrier 10 is changed. As such, the user can rotate the handle 200 to adjust the center of gravity of the child carrier 10, so that the center of gravity of the child carrier 10 moves backward after the handle 200 is rotated, and it is easy to push the child carrier 10.

In other embodiments, the second position may be located above or below the first position. When the second position is located above the first position, the center of gravity of the child carrier 10 moves upward as the rotation of the handle 200. In this way, a height of the child sitting in the child carrier 10 can be increased, an inhalation of harmful gas such as automobile exhaust by the child can be reduced, which is beneficial to the child's health. When the second position is located below the first position, the center of gravity of the child carrier 10 moves downward as the rotation of the handle 200, so that an overall stability of the child carrier 10 can be increased, and the safety performance of the child carrier 10 can be improved.

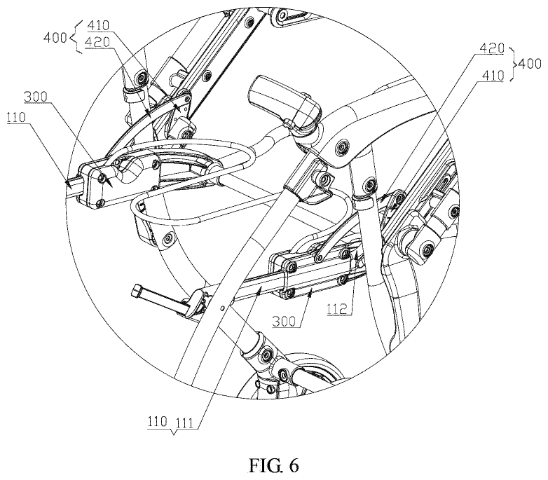

Specifically, as shown in FIGS. 5 and 6, the frame 100 includes a support rod 110, a first wheel support 120, and a second wheel support 130. Ends of the first wheel support 120 and the second wheel support 130 are connected to the first wheel 140 and the second wheel 150, respectively, and the other end of the first wheel support 120 is fixed to the other end of the second wheel support 130 to form a substantially triangular support structure. The support rod 110 is connected between the first wheel support 120 and the second wheel support 130. In this embodiment, the handle 200 is pivotally connected to the support rod 110. Of course, in other embodiments, the handle 200 can also be pivotally connected to the first wheel support 120 or the second wheel support 130.

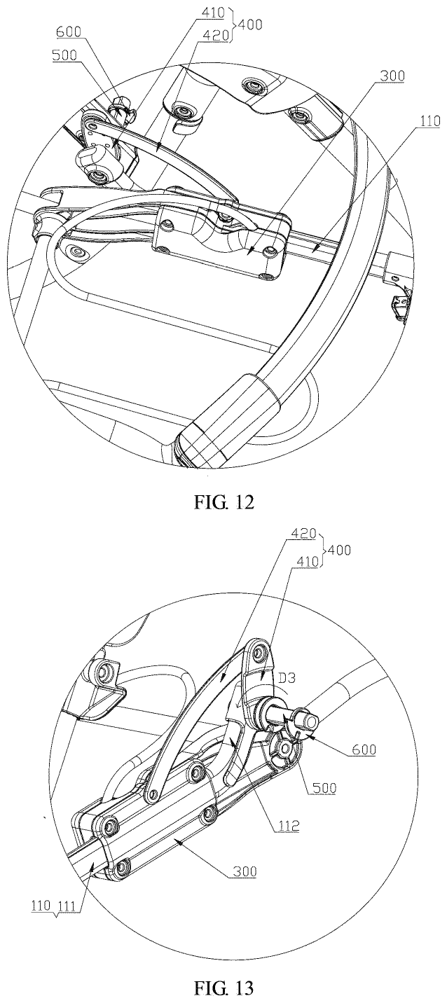

In one embodiment, as shown in FIGS. 1 to 16, the child carrier 10 further includes a first linkage assembly 400, a rotating shaft 500, a fixing sheet 600, and a reinforcing sheet 700. The seat support member 300 is slidably arranged on the support rod 110, and the handle 200 is rotated to drive the seat support member 300 to move along the support rod 110. Specifically, when the handle 200 is rotated, the seat support member 300 is driven to move along the support rod 110 by the first linkage assembly 400. In this embodiment, the seat support member 300 is a sliding sleeve that can be slidably sleeved on the support rod 110. The child carrier 10 further includes a plurality of pulleys (not labeled but shown in FIG. 2) located in the seat support member 300 and abutting against the support rod 110. In this way, a sliding friction between the seat support member 300 and the support rod 110 can be reduced, so that the seat support member 300 can move along the support rod 110 more smoothly. In this embodiment, four pulleys are provided, two of the pulleys abut against an upper side of the support rod 110, the other two pulleys abut against a lower side of the support rod 110. Of course, in other embodiments, a number and arrangement of pulleys can also be varied as required.

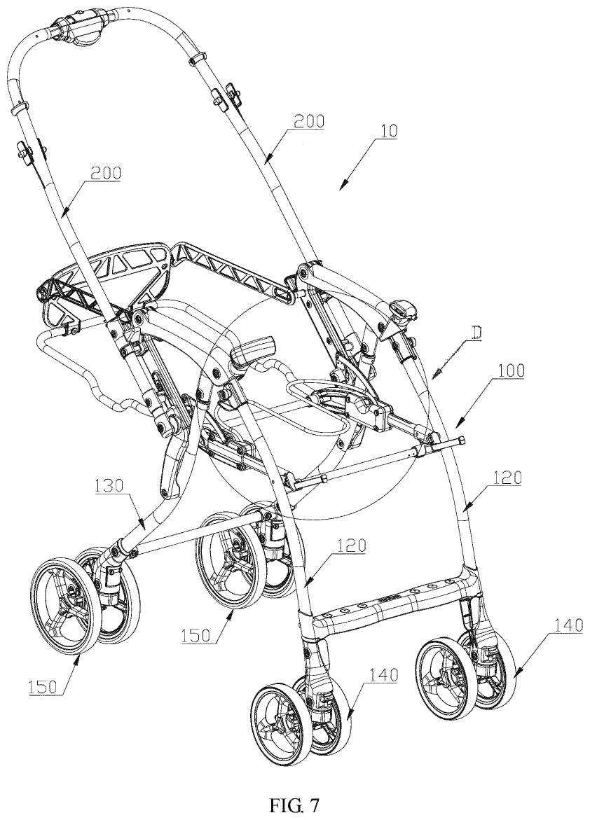

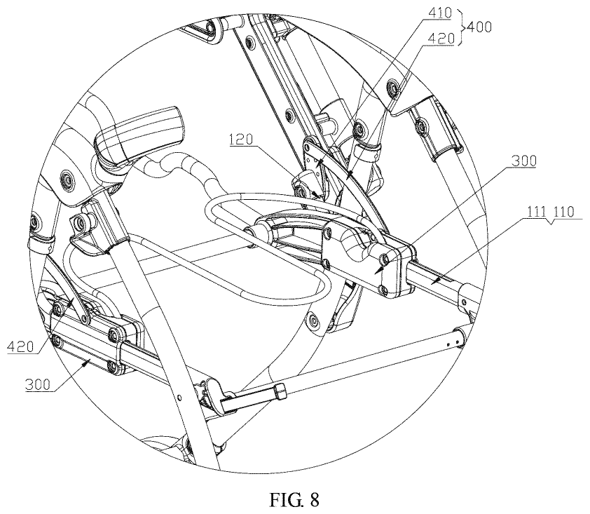

Specifically, as shown in FIGS. 7 and 8, the first linkage assembly 400 may include a rotating member 410 and a driving member 420. As shown in FIG. 8, the rotating member 410 is shaped substantially as an elliptical disk, the driving member 420 is shaped substantially as an arc. In this embodiment, the rotating member 410 and the driving member 420 are both located above the seat support member 300, and a center of the driving member 420 in the arc shape is located below the driving member 420. Of course, in another embodiment, the rotating member 410 and the driving member 420 may both be located below the seat support member 300.

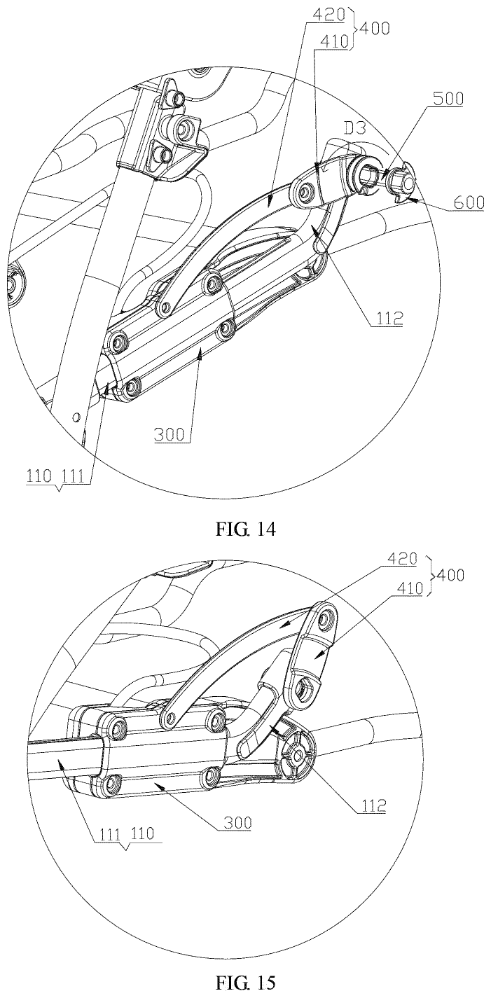

In this embodiment, as shown in FIG. 6, the support rod 110 includes a first rod 111 and a second rod 112 that are connected to each other. The first rod 111 is arranged horizontally, and the second rod 112 forms an angle, e.g. an obtuse angle, with the first rod 111. The handle 200 is pivotally connected to the second rod 112. One end of the rotating member 410 is fixed to the handle 200, the other end of the rotating member 410 is pivotally connected to one end of the driving member 420, the other end of the driving member 420 is pivotally connected to the seat support member 300. In this way, as shown in FIG. 13 and FIG. 14, the rotating member 410, the driving member 420 and the seat support member 300, that are pivotally connected to one another and movable form a structure similar to a link. When the handle 200 is rotated in a third direction D3, such as counterclockwise direction, the rotating member 410 and the driving member 420 rotate and move under a traction of the handle 200, so that the seat support member 300 is driven to move along the support rod 110. Since the seat support member 300 is always moved corresponding to a rotating direction of the handle 200 under the driving of the handle 200, and the handle 200 is always on the same side as the rear wheels relative to the moving direction, the seat support member 300 can be driven automatically to move away from the moving direction along the support rod 110 as the rotation of the handle 200, and the center of gravity of the entire child carrier 10 moves backward, so that it is easy to push the child carrier 10 after the moving direction of the child carrier 100 is changed by rotating the handle 200.

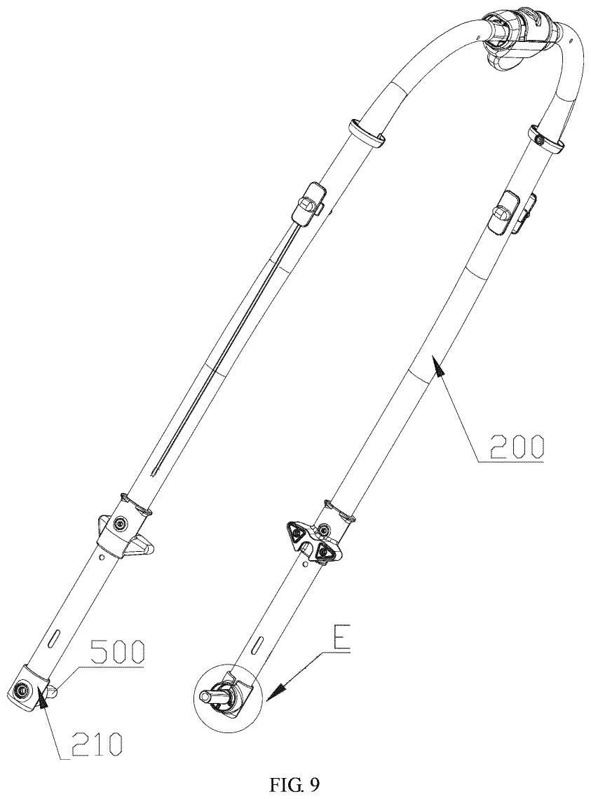

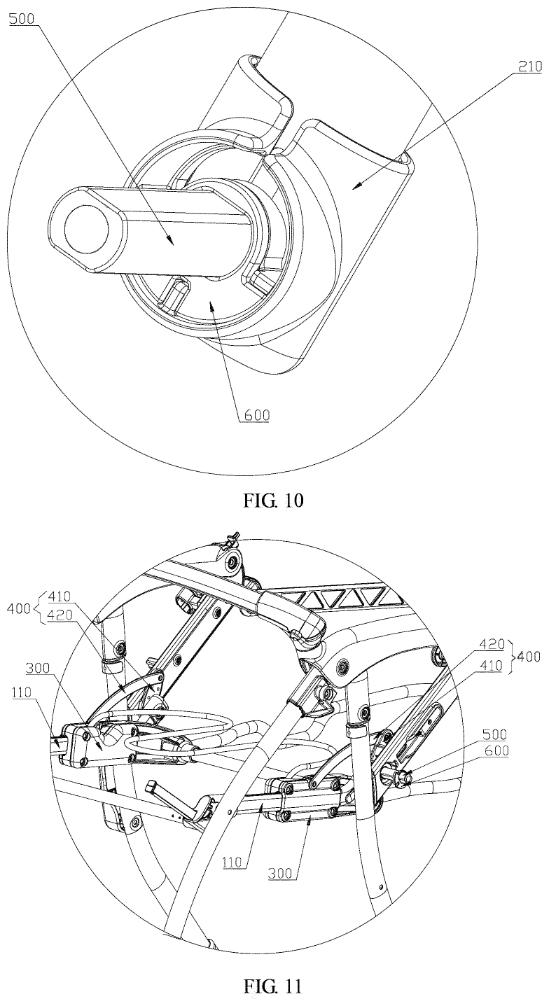

Further, as shown in FIG. 5, FIG. 9, and FIG. 10, the rotating shaft 500 is fixed to the handle 200 and extends through the frame 100, so that the handle 200 is pivotally connected to the frame 100. One end of the rotating member 410 is fixed to the rotating shaft 500. In this way, the handle 200 is pivotally connected to the frame 100 through the rotating shaft 500, and when the handle 200 is rotated, the rotating member 410 can be driven to rotate through the rotating shaft 500, thereby driving the seat support member 300 to move.

Further, as shown in FIG. 5, FIG. 9, and FIG. 10, the handle 200 includes a handle holder 210 that is located at an end of the handle 200. The rotating shaft 500 is fixed to the handle holder 210, and a connection between the rotating shaft 500 and the handle holder 210 can be strengthened by the fixing sheet 600. Specifically, the fixing sheet 600 may be in a shape of a partial gear, the rotating shaft 500 extends through and is fixed into a central hole of the fixing sheet 600, and an edge of the fixing sheet 600 is fixed to the handle holder 210. In this embodiment, an inner wall of the central hole of the fixing sheet 600 is welded to the rotating shaft 500, and an edge of the fixing sheet 600 is welded to the handle holder 210. Of course, in other embodiments, other connection manners may also be used, which are not limited herein.

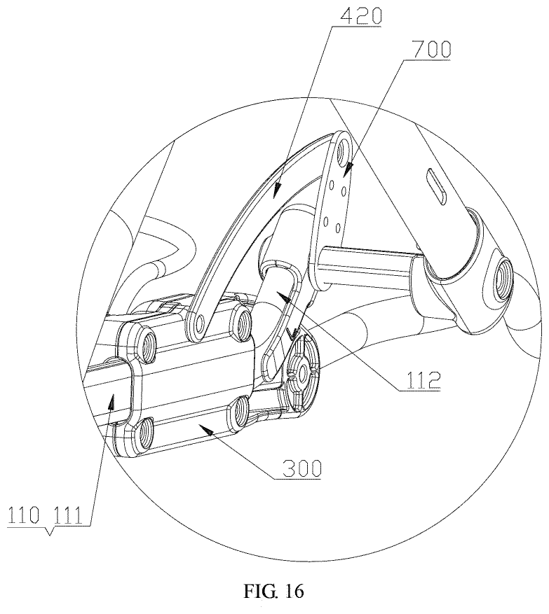

Further, as shown in FIG. 15 and FIG. 16, the reinforcing sheet 700 covers a side surface of the rotating member 410, so as to ensure a strength of the rotating member 410. In this embodiment, the reinforcing sheet 700 is an iron sheet covering an inner side surface of the rotating member 410. Of course, in other embodiments, the reinforcing sheet 700 may also be made of other materials or replaced with another structure.

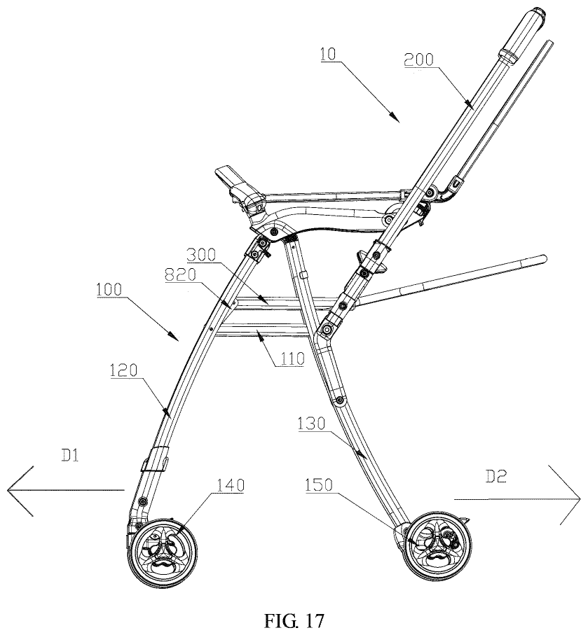

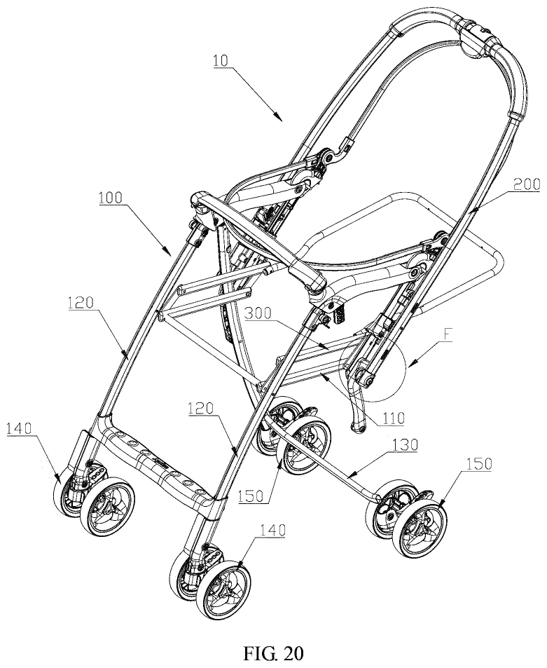

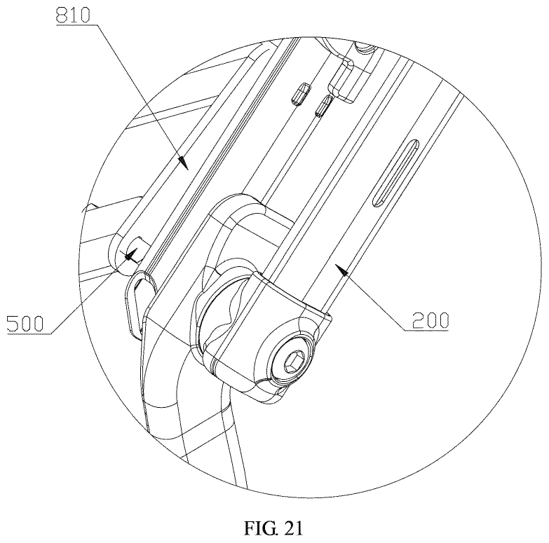

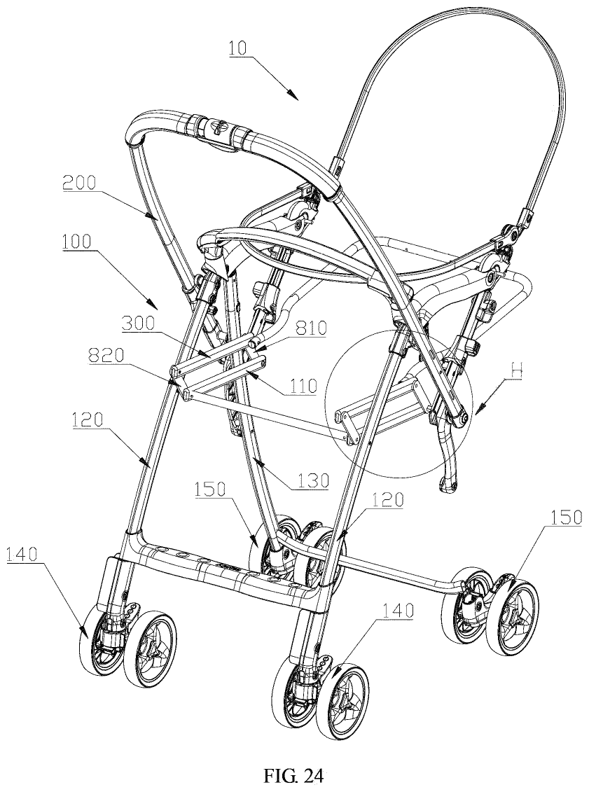

In another embodiment, as shown in FIGS. 17 to 25, the child carrier 10 further includes a second linkage assembly 800 and the rotating shaft 500. The seat support member 300 is connected to the support rod 110 through the second linkage assembly 800, and the handle 200 is rotated to drive the seat support member 300 to move relative to the support rod 110. In this way, the position of the center of gravity of the child carrier 10 can be changed by rotating the handle 200.

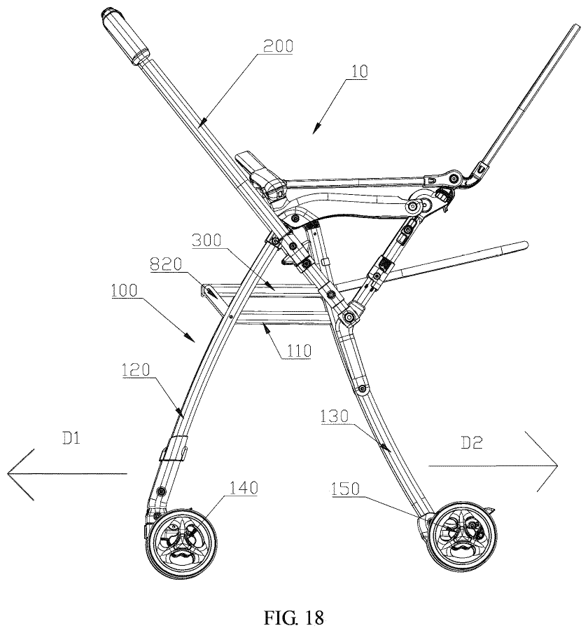

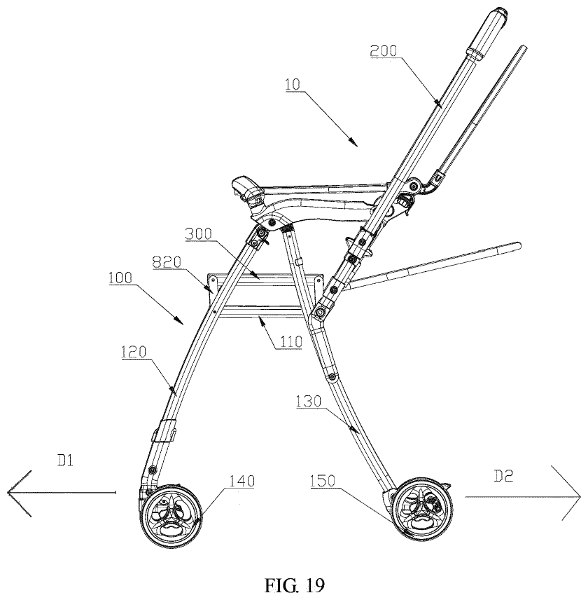

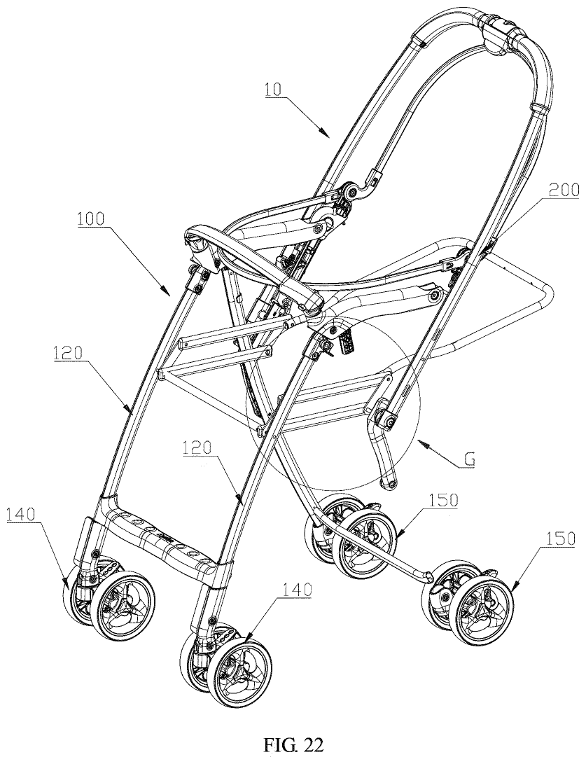

Specifically, as shown in FIGS. 22 to 26, the second linkage assembly 800 may include a first linkage rod 810 and a second linkage rod 820. One end of the first linkage rod 810 is fixed to the handle 200, the other end of the first linkage rod 810 is pivotally connected to one end of the seat support member 300. The other end of the seat support member 300 is pivotally connected to one end of the second linkage rod 820, the other end of the second linkage rod 820 is pivotally connected to the support rod 110. The first linkage rod 810, the seat support member 300, the second linkage rod 820, and the support rod 110 are connected in sequence to form a deformable quadrilateral structure. In this embodiment, the first linkage rod 810, the seat support member 300, and the second linkage rod 820 are all located above the support rod 110. Of course, in other embodiments, the first linkage rod 810, the seat support member 300, and the second linkage rod 820 may all be located below the support rod 110. In this way, on the one hand, as shown in FIGS. 17 and 18, when the handle 200 is rotated in the third direction D3, the first linkage rod 810, the seat support member 300, and the second linkage rod 820 can rotate and move under the traction of the handle 200. Since the seat support member 300 is always moved corresponding to a rotating direction of the handle 200 under the driving of the handle 200, and the handle 200 is always on the same side as the rear wheels relative to the moving direction, the seat support member 300 can be driven automatically to move away from the moving direction along the support rod 110 as the rotation of the handle 200, and the center of gravity of the entire child carrier 10 moves backward, so that it is easy to push the child carrier 10 after the moving direction of the child carrier 100 is changed by rotating the handle 200. On the other hand, as shown in FIGS. 18 and 19, since the first linkage rod 810, the seat support member 300, the second linkage rod 820, and the support rod 110 form the deformable quadrilateral structure, during the rotation of the handle 200, a distance between the seat support member 300 and the support rod 110 can also be changed. That is, the height of the seat support member 300 is changed, so that the height of the center of gravity of the child carrier 10 is changed. In this way, the user can adjust the height of the center of gravity of the child carrier 10 as required by rotating the handle 200.

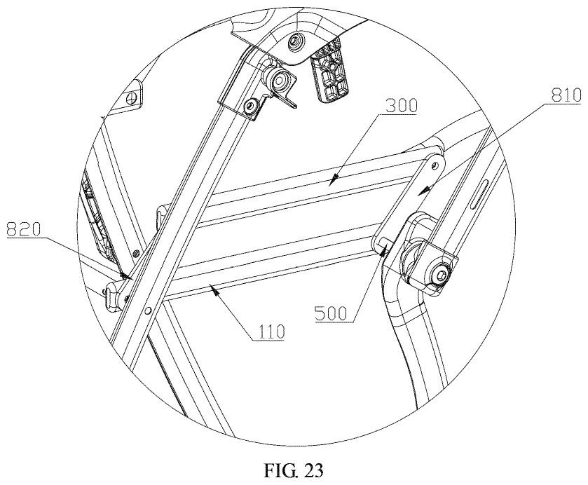

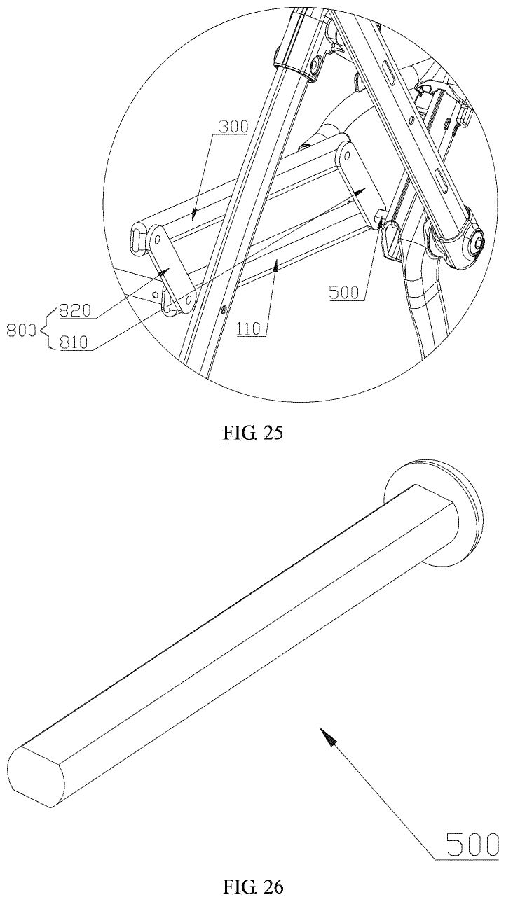

Specifically, as shown in FIG. 21, FIG. 23 and FIG. 25, the rotating shaft 500 is fixed to the handle 200 and extends through the frame 100, so that the handle 200 is pivotally connected to the frame 100. One end of first linkage rod 810 is fixed on the rotating shaft 500. In this way, the handle 200 is pivotally connected to the frame 100 through the rotating shaft 500, and when the handle 200 is rotated, the first linkage rod 810 can be driven to rotate through the rotating shaft 500, thereby driving the seat support member 300 to move. In this embodiment, as shown in FIG. 26, a cross-section of the rotating shaft 500 is substantially square, the first linkage rod 810 is provided with a through hole (not shown), and the rotating shaft 500 extends through the through hole and is in an interference fit with the through hole.

The above-mentioned child carrier 10 has at least the following technical effects.

The handle 200 of the aforementioned child carrier 10 can be rotated relative to the frame 100, so that the seat support member 300 can move relative to the frame 100 from the first position to the second position. Since the seat support member 300 is configured to support the seat, the child sitting on the seat can move along with the seat support member 300, that is, the center of gravity of the entire child carrier 10 is changed. As such, the user can rotate the handle 200 to adjust the center of gravity of the child carrier 10, so that the center of gravity of the child carrier 10 moves backward after the moving direction of the child carrier 100 is changed by rotating the handle 200, and it is easy to push the child carrier 10. In addition, the center of gravity of the child carrier 10 can be moved upward to reduce children's inhalation of automobile exhaust, or the center of gravity of the child carrier 10 can be moved downward to increase the stability of the child carrier 10 as a whole.

Although the respective embodiments have been described one by one, it shall be appreciated that the respective embodiments will not be isolated. Those skilled in the art can apparently appreciate upon reading the disclosure of this application that the respective technical features involved in the respective embodiments can be combined arbitrarily between the respective embodiments as long as they have no collision with each other. Of course, the respective technical features mentioned in the same embodiment can also be combined arbitrarily as long as they have no collision with each other.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall all fall within the protection scope of the present disclosure. Therefore, the protection scope of the present disclosure shall be subject to the protection scope of the appended claims.

1. A child carrier, comprising:
a frame;
a seat support member configured to support a seat; and
a handle pivotally connected to the frame, wherein the handle is capable of rotating relative to the frame to drive the seat support member to move relative to the frame from a first position to a second position.

2. The child carrier according to claim 1, wherein the frame comprises a support rod, the seat support member is slidably connected to the support rod, and the handle is capable of rotating to drive the seat support member to move along the support rod.

3. The child carrier according to claim 2, wherein the support rod is arranged along a first direction, the handle is capable of rotating relative to the frame to change a moving direction of the frame from the first direction to a second direction, and to drive the seat support member to move relative to the frame from the first direction to the second direction, and the second position is located in the first direction of the first position.

4. The child carrier according to claim 2, further comprising a first linkage assembly, wherein the handle drives the seat support member to move along the support rod through the first linkage assembly.

5. The child carrier according to claim 4, wherein the first linkage assembly comprises a rotating member and a driving member, one end of the rotating member is connected to the handle, another end of the rotating member is pivotally connected to one end of the driving member, and another end of the driving member is pivotally connected to the seat support member.

6. The child carrier according to claim 5, wherein the rotating member and the driving member are located above the seat support member.

7. The child carrier according to claim 5, further comprising a rotating shaft, wherein the rotating shaft is fixed to the handle and extends through the frame to enable the handle to be pivotally connected to the frame, and the end of the rotating member is fixed to the rotating shaft.

8. The child carrier according to claim 7, wherein the handle comprises a handle holder, and the rotating shaft is connected to the handle holder.

9. The child carrier according to claim 2, wherein the seat support member is slidably sleeved on the support rod.

10. The child carrier according to claim 2, further comprising a plurality of pulleys located in the seat support member and abutting against the support rod.

11. The child carrier according to claim 5, further comprising a reinforcing sheet covering a side surface of the rotating member.

12. The child carrier according to claim 1, further comprising a second linkage assembly, wherein the frame comprises a support rod, the seat support member is connected to the support rod through the second linkage assembly, and the handle is capable of rotating to drive the seat support member to move relative to the support rod.

13. The child carrier according to claim 12, wherein the support rod is arranged along a first direction, the handle is capable of rotating relative to the frame to change a moving direction of the frame from the first direction to a second direction, and to drive the seat support member to move relative to the frame from the first direction to the second direction, the second position is located in the first direction of the first position.

14. The child carrier according to claim 12, wherein the support rod is arranged along a first direction, and the second position is located above or below the first position.

15. The child carrier according to claim 12, wherein the second linkage assembly comprises a first linkage rod and a second linkage rod, one end of the first linkage rod is fixed to the handle, another end of the first linkage rod is pivotally connected to one end of the seat support member, another end of the seat support member is pivotally connected to one end of the second linkage rod, and another end of the second linkage rod is pivotally connected to the support rod; and
wherein the first linkage rod, the seat support member, the second linkage rod, and the support rod are connected in sequence to form a deformable quadrilateral structure.

16. The child carrier according to claim 15, wherein the first linkage rod, the seat support member, and the second linkage rod are located above the support rod.

17. The child carrier according to claim 15, further comprising a rotating shaft, wherein the rotating shaft is fixed to the handle and extends through the frame to enable the handle to be pivotally connected to the frame, and the end of the first linkage rod is fixed to the rotating shaft.
